(19) United States
(12) Patent Application Publication
(10) Pub. No.: US 2015/0167550 A1
(43) Pub. Date: Jun. 18, 2015

(54) SYSTEM AND METHOD FOR PROCESSING GAS STREAMS

(71) Applicant: General Electric Company, Schenectady, NY (US)

(72) Inventors: Christian Lee Vandervort, Voorheesville, NY (US); Stephen Duane Sanborn, Copake, NY (US); Joel Meier Haynes, Niskayuna, NY (US); Harish Radhakrishna Acharya, Clifton Park, NY (US); Ross Hartley Kenyon, Jay, NY (US)

(73) Assignee: General Electric Company, Schenectady, NY (US)

(21) Appl. No.: 14/132,198

(22) Filed: Dec. 18, 2013

(51) Int. Cl. F02C 3/20; F02C 6/00; C10L 3/10

(52) U.S. Cl. CPC F02C 3/20; C10L 3/10; F02C 6/00; F05D 2240/35; F05D 2270/08

(57) ABSTRACT

A system for processing a gas stream includes a gathering subsystem configured to collect the gas stream from a well-head and a gas conditioning subsystem for receiving the gas stream from the gathering subsystem and providing physical conditioning of the gas stream. The system includes one or more gas turbines configured to receive and combust a first flow of the conditioned gas stream from the gas conditioning subsystem and coupled with an electrical generator. The system includes one supplemental combustor configured to receive heated exhaust gases from the one or more gas turbines and a second flow of the conditioned gas stream from the gas conditioning subsystem, wherein the at least one supplemental combustor is configured to combust the second flow of the conditioned gas stream and the heated exhaust gases such that an exhaust gas stream flow from the at least one supplemental combustor meets emission regulation requirements.

### BACKGROUND

The present technology relates generally to processing of gas streams and, more specifically, to processing of gas streams from unconventional oil wells for meeting emission regulation requirements.

Generally, unconventional oil wells produce gas streams that contain associated petroleum gases (APG) as byproducts. These gas streams are primarily composed of gaseous hydrocarbons but can also contain inert gases, liquids, solids, and corrosive species. Releasing the gas streams into the atmosphere causes environmental pollution due to various components of gases that are classified as air pollutants by regulatory agencies such as the United States of America Environmental Protection Agency. In order to mitigate emissions from the gas streams, the associated petroleum gases are generally flared or combusted by using simple burners as the gas streams exit the unconventional oil wells. These burners are mostly commercially available. Unfortunately, the flared gas streams do not achieve complete combustion and produce a number of pollutants in unacceptable quantities, thus failing to meet emission regulation requirements. Pollutants of concern include oxides of nitrogen (NOx), carbon monoxide (CO), unburned hydrocarbons (UHC), volatile organic compounds (VOC), particulate matter (PM), and hydrogen sulfide (H2S). The flared gas streams also contribute to carbon dioxide gas levels via the combustion reaction between the gaseous hydrocarbons and air. The challenge of emissions from flare gas burners is also complicated by flow rates of flare gas streams that fluctuate at high magnitudes. Further, there are no useful byproducts when gas streams are flared or combusted using these burners.

There is therefore a desire for a system and method for processing the gas streams such that there is combustion of gas streams in a very clean manner and production of useful by-products such as commercially valuable liquefied natural gas (LNG), condensates (ethane, propane, butane), sulfur, and electricity.

### BRIEF DESCRIPTION

In accordance with an example of the technology, system for processing a gas stream includes a gathering subsystem configured to collect the gas stream from a well-head and a gas conditioning subsystem for receiving the gas stream from the gathering subsystem and providing physical conditioning of the gas stream. The system includes one or more gas turbines configured to receive and combust a first flow of the conditioned gas stream from the gas conditioning subsystem and coupled with an electrical generator. The system also includes one supplemental combustor configured to receive heated exhaust gases from the one or more gas turbines and a second flow of the conditioned gas stream from the gas conditioning subsystem. The supplemental combustor is configured to combust the second flow of the conditioned gas stream and the heated exhaust gases such that an exhaust gas stream flow from the at least one supplemental combustor meets emission regulation requirements.

In accordance with an example of the technology, a method of processing a gas stream includes gathering the gas stream from a well-head into a gathering subsystem and conditioning the gas stream that is routed to a gas conditioning subsystem from the gathering subsystem. The method also includes directing a first flow of the conditioned gas stream from the gas conditioning subsystem to one or more gas turbines for combustion. The one or more gas turbines are configured to drive a power generation system. Further, the method includes combusting a second flow of the conditioned gas stream from the gas conditioning subsystem along with exhaust gases from the one or more gas turbines in at least one supplemental combustor such that an exhaust gas stream flow from the at least one supplemental combustor meets emission regulation requirements.

In accordance with an example of the technology, a system for processing a gas stream includes a gathering subsystem configured to collect the gas stream from a well-head. The system also includes a gas conditioning subsystem configured to receive the gas stream from the gathering subsystem and provide physical conditioning of the gas stream. The system includes a liquefied natural gas processing unit configured to process a methane gas to produce a first natural gas liquid product and a compressed natural gas processing unit configured to produce a second natural gas liquid product. The system also includes one or more gas turbines configured to receive and combust a first flow of the conditioned gas stream from the gas conditioning subsystem and coupled with a power generation system. Further, the system includes at least one supplemental combustor configured to receive heated exhaust gases from the one or more gas turbines and a second flow of the conditioned gas stream from the gas conditioning subsystem. The supplemental combustor is configured to combust the second flow of the conditioned gas stream and the heated exhaust gases such that an exhaust gas stream flow from the at least one supplemental combustor meets emission regulation requirements. Furthermore, the system includes a carbon dioxide capture subsystem located downstream of the at least one supplemental combustor and configured to capture carbon dioxide (CO₂) gas from a portion of the exhaust gas stream flow and convert the captured CO₂ to a concentrated CO₂ or liquid CO₂.

### DRAWINGS

These and other features, aspects, and advantages of the present technology will become better understood when the following detailed description is read with reference to the accompanying drawings in which like characters represent like parts throughout the drawings, wherein:

FIG. 1 is a schematic diagram representative of a system for processing gas streams in accordance with an example of the present technology;

FIG. 2 is a schematic diagram representative of a system for processing gas streams in accordance with another example of the present technology;

FIG. 3 is a schematic diagram representative of a system for processing gas streams in accordance with another example of the present technology;

FIG. 4 is a schematic diagram representative of a system for processing gas streams in accordance with an example of the present technology;

FIG. 5 is a schematic diagram representative of a system for processing gas streams in accordance with an example of the present technology;

FIG. 6 is a schematic diagram representative of a system for processing gas streams in accordance with an example of the present technology;

FIG. 7 is a schematic diagram representative of a system for processing gas streams in accordance with another example of the present technology;

FIG. 8 is a flow chart of a method of processing a gas stream in accordance with an example of the present technology.

### DETAILED DESCRIPTION

When introducing elements of various embodiments of the present technology, the articles “a,” “an,” “the,” and “said” are intended to mean that there are one or more of the elements. The terms “comprising,” “including,” and “having” are intended to be inclusive and mean that there may be additional elements other than the listed elements. Any examples of operating parameters are not exclusive of other parameters of the disclosed examples.

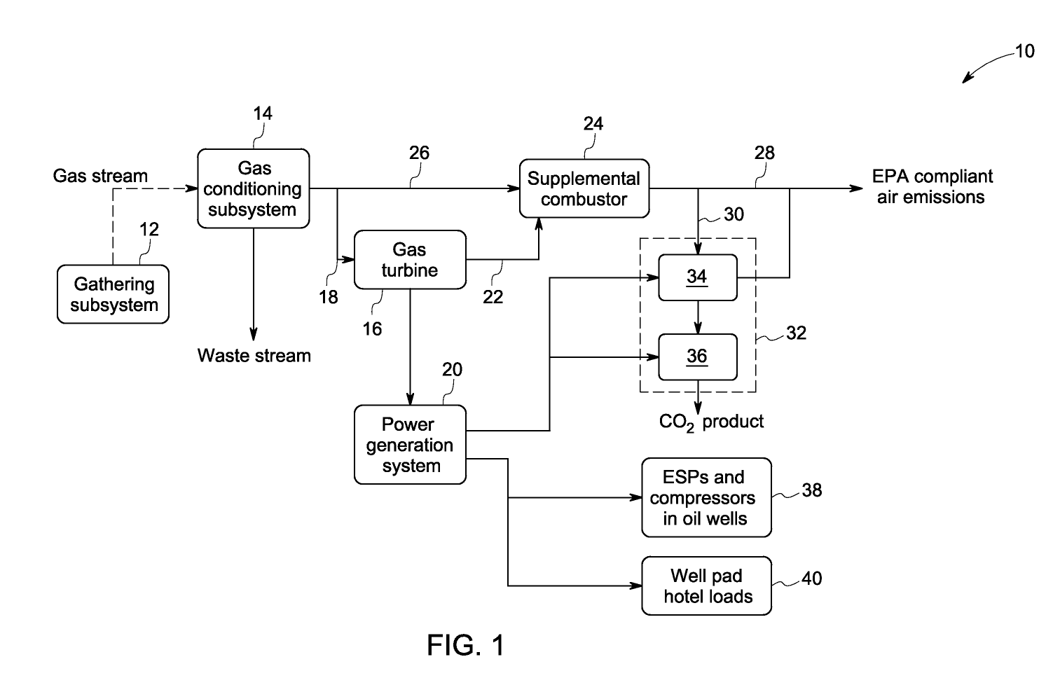

FIG. 1 is a schematic diagram representative of a system 10 for processing gas streams in accordance with an example of the present technology. As shown, the system 10 includes a gathering subsystem 12 configured to collect the gas stream from a well-head (not shown). The system 10 includes a gas conditioning subsystem 14 configured to receive the gas stream from the gathering subsystem 12 and provide physical conditioning of the gas stream. The physical conditioning of the gas stream by the gas conditioning subsystem 14 includes filtration of solids present in the gas streams such as salts and proppants using filters and further removal of moisture using sorbents. The removed salts, proppants and moisture are then disposed of as waste stream. In one example, the gas conditioning subsystem 14 may also be configured to heat the gas stream to ensure that liquid hydrocarbons, such as butane, pentane and hexane, if present, are in vapor phase. In this example as shown in FIG. 1, the system 10 includes a gas turbine 16 that receives a first flow 18 of conditioned gas stream from the gas conditioning subsystem 14. The gas turbine 16 is coupled with a power generation system 20 for generating electric power. In a non-limiting example, the gas turbine 16 may be produce 1 megawatt to 5 megawatts of electric power. Further, in a non-limiting example, the electricity generated from power generation system 20 may be supplied to any subsystem requiring an electric power for operation. The exhaust gases 22 from the gas turbine 16 is routed to a supplemental combustor 24 which utilizes the heat from the exhaust gases 22 to combust a second flow 26 of the conditioned gas stream that is directed into the supplemental combustor 24 from the gas conditioning subsystem 14. The second flow 26 includes excess conditioned gas streams that mainly includes higher hydrocarbon gases such as such as C2. (ethane, ethylene, acetylene), C3 (propane), C4 (butane), and C5 (pentane). The supplemental combustor 24 sufficiently combusts the higher hydrocarbon gases of the second flow 26 along with the exhaust gases 22 of the gas turbine 16 to produce an exhaust gas stream flow 28 that meets emission regulation requirements that can be released in the atmosphere. In one example, the system for processing gas streams may not include the supplemental combustor and the gas turbine may sufficiently combust the conditioned gas streams to produce exhaust gases that meets the emission regulation requirements.

In this example, a portion 30 of the exhaust gas stream flow 28 after exiting the supplemental combustor 24 is routed to a carbon dioxide capture subsystem 32 located downstream of the supplemental combustor prior to releasing the exhaust gas stream flow 28 into the atmosphere, thereby, meeting air emission regulations. The carbon dioxide capture subsystem 32 is configured to capture carbon dioxide (CO₂) gas by a CO₂ capture unit 34 and further process the captured CO₂ by a CO₂ process unit 36 to produce a concentrated CO₂ or liquid CO₂.

Further, the power generation system 18 includes an electric generator (not shown) and an electric load bus configured to provide power to a plurality of subsystems of the system 10. As shown in FIG. 1, the electricity generated by the power generation system 18 is distributed via the electric load bus to power the CO₂ capture unit 34 and the CO₂ process unit 36 of the carbon dioxide capture subsystem 32. The electricity generated may also be distributed to the gas conditioning subsystem 14, power oil well requirements 38 for driving multiple electric submersible pumps and compressors and well pad hotel loads 40.

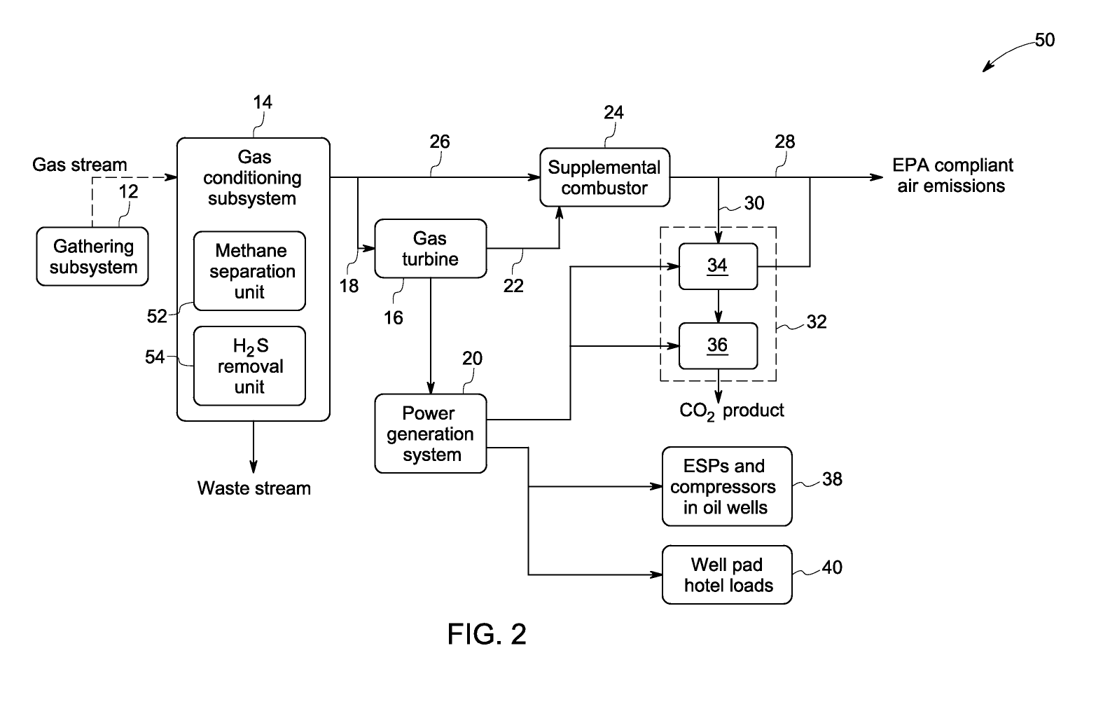

FIG. 2 is a schematic diagram representative of a system 50 for processing gas streams in accordance with another example of the present technology. The system 50 is similar to system 10 shown in FIG. 1, except that in this example, the gas conditioning subsystem 14 may be further configured to separate higher hydrocarbon gases from lower hydrocarbon gases present in the gas stream and remove sulphur or sulphur based compounds from the gas streams prior to routing the conditioned gas stream to the gas turbine and the supplemental combustor for further combustion. For achieving this, the gas conditioning subsystem 14 includes a methane separation unit 52 that separates lower hydrocarbon gases such as methane from higher hydrocarbon gases. The gas conditioning subsystem 14 further includes a hydrogen sulphide removal unit 54 for removing the sulphur or sulphur based compounds present in the gas stream.

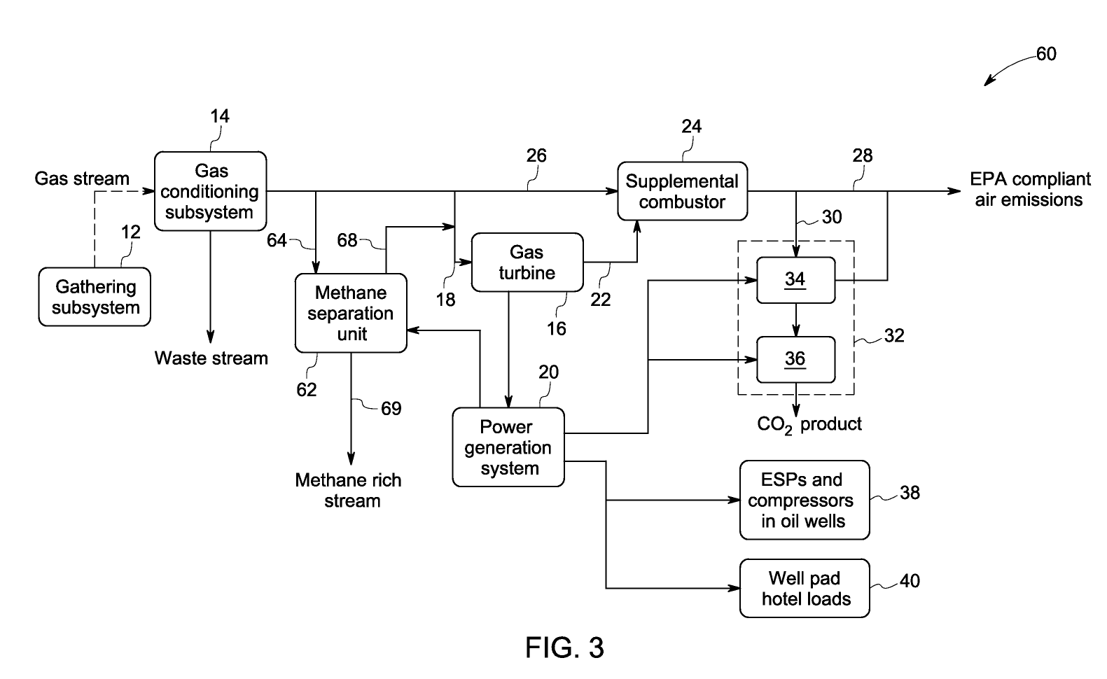

FIG. 3 is a schematic diagram representative of a system 60 for processing gas streams in accordance with another example of the present technology. The system 60 includes a methane separation unit 62 that is located outside the gas conditioning unit 14 configured to separate lower hydrocarbon gases such as methane from higher hydrocarbon gases. A portion 64 of the conditioned gas stream may be directed to methane separation unit 62 for separating methane gas. Another portion 66 of conditioned gas stream is further delivered to the gas turbine 16 and the supplemental combustor 24 via fluid lines 18 and 26 respectively. In one example, the higher hydrocarbon gases separated in the methane separation unit 62 to produce a substantially methane rich stream 69 and a stream 68 that is rich in the higher hydrocarbons and is directed to the gas turbine 16 via a fluid line for combustion. The separated methane gas shown as methane rich stream 69 may be further processed in Liquefied Natural Gas (LNG) processing unit (not shown) and a Compressed Natural Gas (CNG) processing unit (not shown) to produce to produce corresponding LNG and CNG products. In one example, the higher hydrocarbons rich stream 68 may be collected as natural gas liquid products (NGLs) and may be sold as a commercial product. As shown in FIG. 3, the electricity generated by the power generation system 20 is distributed via the electric load bus to power the methane separation unit 62.

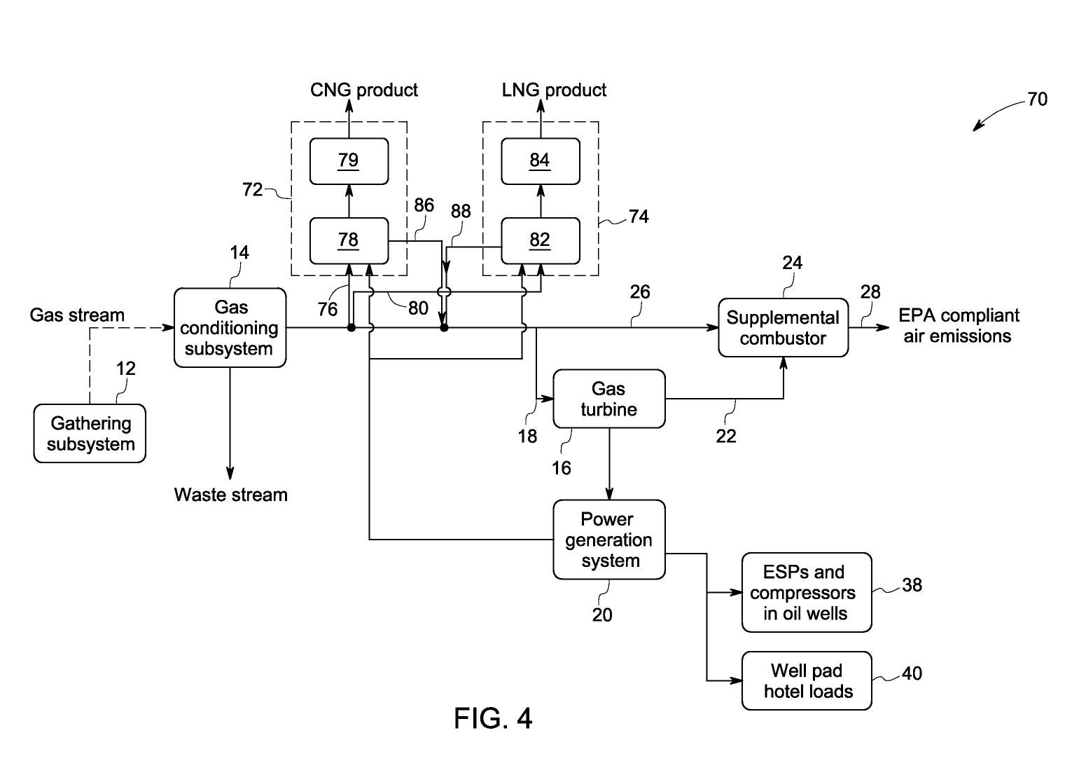

FIG. 4 is a schematic diagram representative of a system 70 for processing gas streams in accordance with an example of the present technology. As shown in this example, the system 70 includes a Compressed Natural Gas (CNG) processing unit 72 for processing a portion 76 of the conditioned gas stream to produce a CNG product. The CNG processing unit 72 includes a CNG conditioning unit 78 for conditioning the gas stream and then further processing in a unit 79 to finally produce the CNG product. The system 70 also includes a Liquefied Natural Gas (LNG) processing unit 74 for processing a portion 80 of the conditioned gas stream to produce a LNG product. The LNG processing unit 74 includes a LNG conditioning unit 82 for conditioning the gas stream and then further processing in a unit 84 to finally produce the LNG product. Both the CNG and the LNG products may be or sold as a commercial product. The residual gases from the CNG conditioning unit 78 and LNG conditioning unit 82 may be routed via fluid line 86 and 88, respectively to the gas turbine 16 or the supplemental combustor 24 for combustion. In one example, both the CNG and the LNG products may be routed via fluid lines 86 and 88 respectively into the gas stream flow path that is further directed to the gas turbine 16 or the supplemental combustor 24 for combustion. Both the CNG processing unit 72 and the LNG processing unit 74 are powered by the power generation system 20. It is to be noted that this system 70 does not include any CO₂ capture unit but is similar to systems 10, 50, 60 as discussed in FIG. 1, FIG. 2 and FIG. 3.

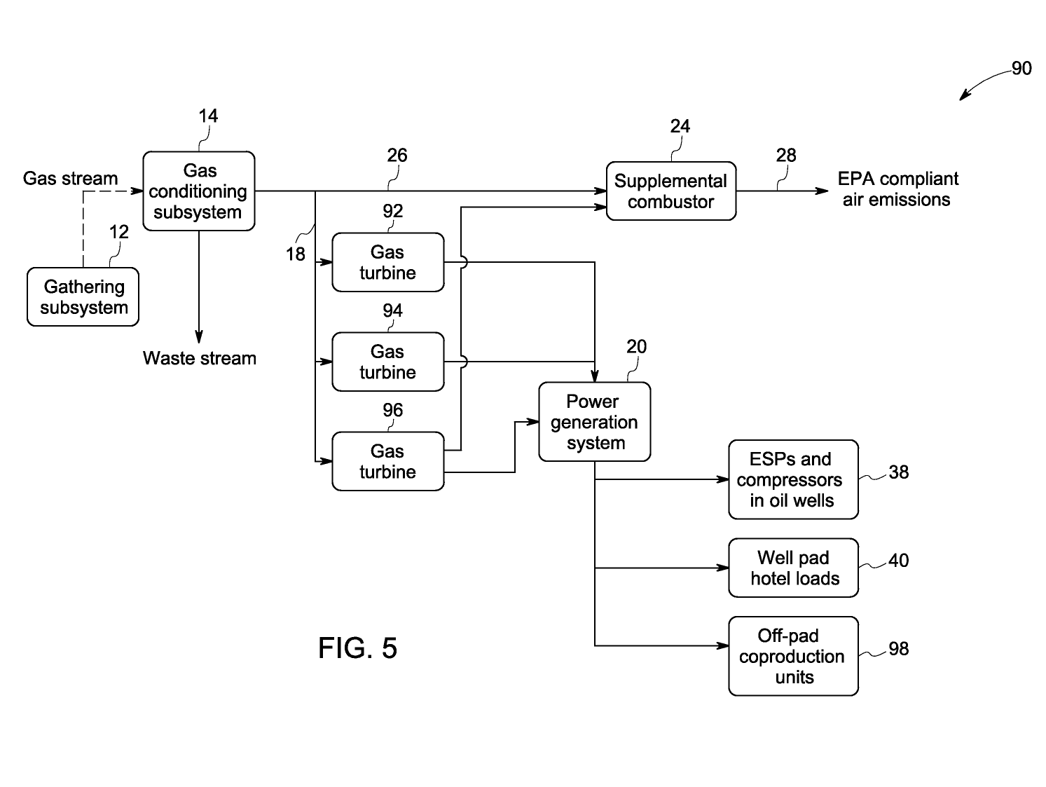

FIG. 5 is a schematic diagram representative of a system 90 for processing gas streams in accordance with an example of the present technology. In this example, the system 90 includes increased electric power generation due to operation of three gas turbines 92, 94 and 96 respectively that receive flow of conditioned gas stream 18 from the gas conditioning unit 14. The power generation system 20 including the electric generator and electric load bus is then configured to distribute the electricity to meet power requirements at location 38 in oil wells for operating electric submersible pumps and compressors. The electricity is also distributed to location 40 that includes well pad hotel loads and location 98 that includes off-pad coproduction units. It is to be noted that in this example, there is no CO₂ capture unit and remaining subsystems of system 90 remains similar to the system 10 as discussed in FIG. 1.

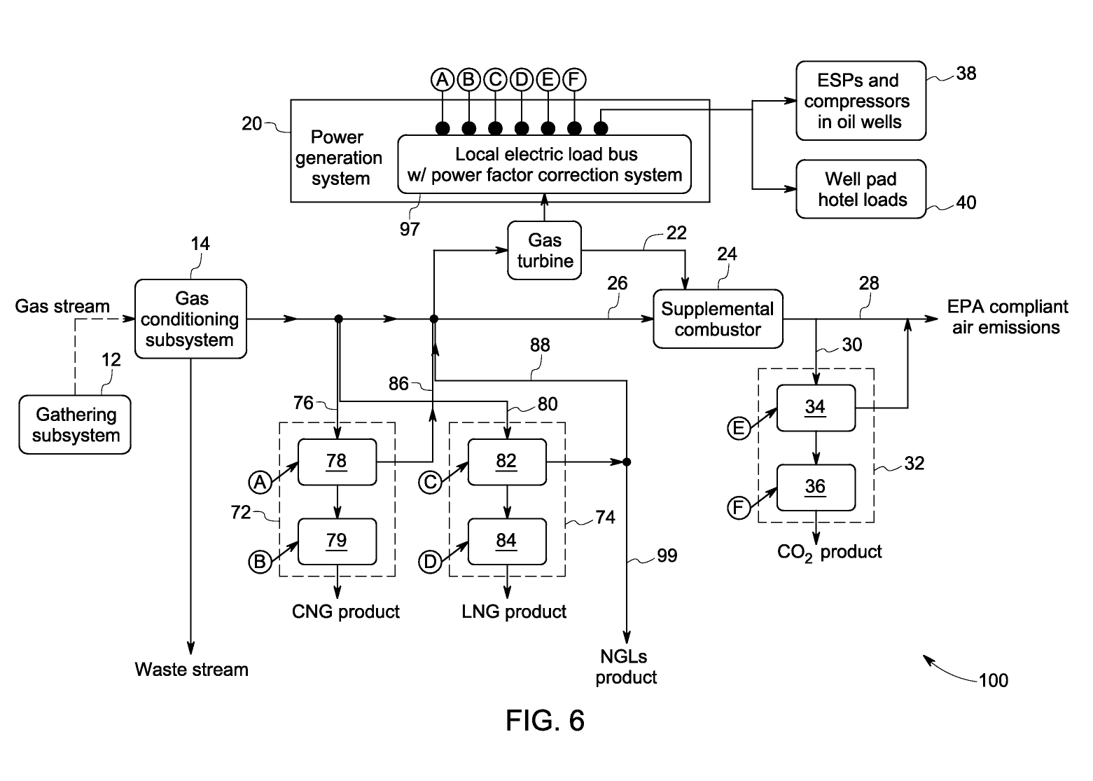

FIG. 6 is a schematic diagram representative of a system 100 for processing gas streams in accordance with an example of the present technology. As shown, the system 100 incorporates the subsystems as discussed in FIG. 1, FIG. 2, FIG. 3 and FIG. 4. In this example, the system 100 includes a flow path 99 that directs natural gas liquids (NGLs) formed in the LNG processing unit 74 to be collected for commercial use. The flow path 88 may also direct the natural gas liquids (NGLs) formed in the LNG processing unit 74 to flow paths that lead to gas turbine 16 or supplemental combustor 24 for combustion. The system 100 also shows the power generation system 20 having a local electric load bus 97 with power correction system that allows distribution of power to a plurality of locations 38, 40 for operation. The local electric load bus 97 may also distribute electric power for operating the CNG processing unit 72, the LNG processing unit 74 and the carbon dioxide capture subsystem 32.

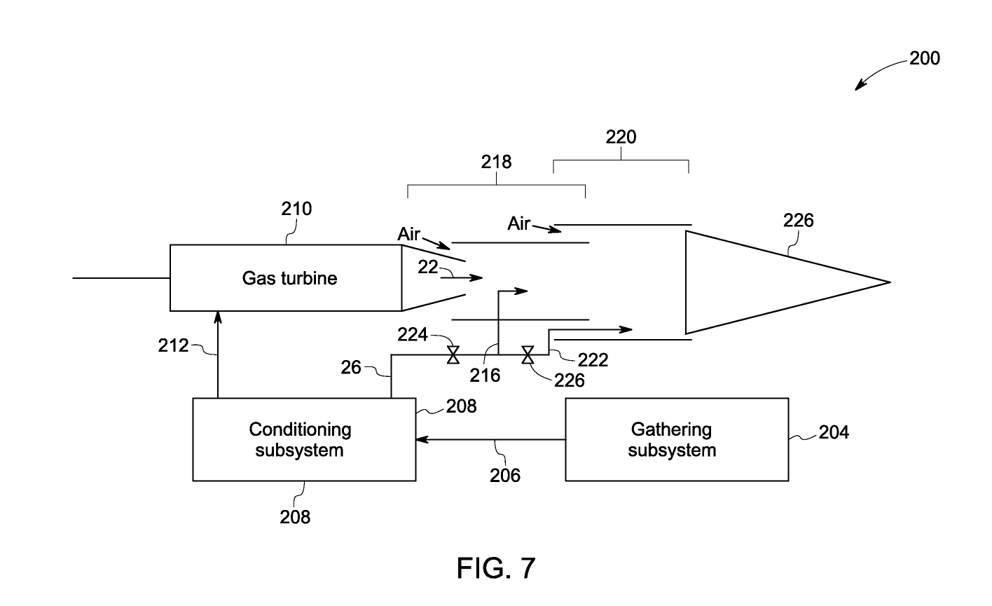

FIG. 7 is a schematic diagram representative of a system 200 for processing gas streams in accordance with another example of the present technology. The system 200 includes a gathering subsystem 204 that captures gas streams that are petroleum associated gases from oil wells. The gas stream is routed via a flow path 206 to conditioning subsystem 208 that is configured to filter solids present in the gas streams such as salts, proppants using filters and further removes moisture from gas streams using sorbents. The conditioning subsystem 208 is also configured to separate lower hydrocarbon gases from higher hydrocarbon gases from the gas streams. In one example, the conditioning subsystem 208 further includes multiple subsystems having membranes, solvents and sorbents that may enable in separating desired compounds such as higher hydrocarbons, carbon dioxide, hydrogen sulphide from the methane gases. Further, a first flow of the conditioned gas stream is routed to a gas turbine 210 via a flow path 212 for combustion. Furthermore, the system 200 illustrates a multistage supplemental combustor 214 configured to operate in the heated exhaust gases 22 from the gas turbine 210 for improving combustion efficiency and reducing soot output from the system 200. In this non-limiting example, the multistage supplemental combustor 214 includes a first stage combustor section 218 and a second stage combustor section 220. In a non-limiting example, the the multistage supplemental combustor includes multiple combustor sections for combusting the conditioned gas streams in multiple stages. A second flow 26 of conditioned gas stream is directed from the conditioning subsystem 208 via two flow paths 216, 222 into the first stage combustor section 218 and the second stage combustor section 220 respectively for combustion. The first stage combustor section 218 also receives the heated exhaust gases from the gas turbine 210 and the flow 26 of conditioned gas stream via the flow path 216. The second flow of conditioned gas stream may include mostly higher hydrocarbon liquids or gases. In one example, the first stage combustor section 218 or second stage combustor section 220 may receive a flow of gas stream directly from the well head for combustion. As shown, at inlet of each of the multiple stage combustor sections of the supplemental combustor 214, air may be introduced so as to allow complete combustion within the combustor stages. A first flow of air and a second flow of air is provided in the first stage combustor section 218 and in a second stage combustor section 220 respectively. The first flow of air is pre-heated by exhaust gases from the gas turbine 210 prior to providing the first flow of air in the first stage combustor section 218 and the flow of second air is pre-heated by the first stage combustor section 218 prior to providing second flow of air in the second stage combustor section 220. Moreover, the combustion within the multistage supplemental combustor 214 may be controlled by regulating the gas stream flow by operating multiple control valves 224, 226 disposed on the flow paths 216, 222 respectively. It is to be noted that the systems 10, 50, 60, 70, 90, 100 as shown in FIG. 1, FIG. 2, FIG. 3, FIG. 4, FIG. 5 and FIG. 6 respectively may include the multistage supplemental combustor 214 having the first stage and second stage combustor sections 218, 220 that are supplied with portions of conditioned gas streams via flow paths 216, 222 controlled by the control valves 224, 226 respectively as shown in FIG. 7. Operation of the multistage combustor in the high temperature environment created by the exhaust of gas turbine 210 creates an exhaust gas stream flow 226 from the multistage supplemental combustor 214 that meets emission regulation requirements. The multistage design allows the multistage combustor 214 to operate over a wide variety of gas supply flow rates, a key challenge identified in traditional gas flare burners. At low flow rates, only a single stage of the multistage combustor 214 may be operated. As the flow rate increases, subsequent stages may be activated. Alternatively, operation can switch from the first stage combustor section 218 to the second stage combustor section 220.

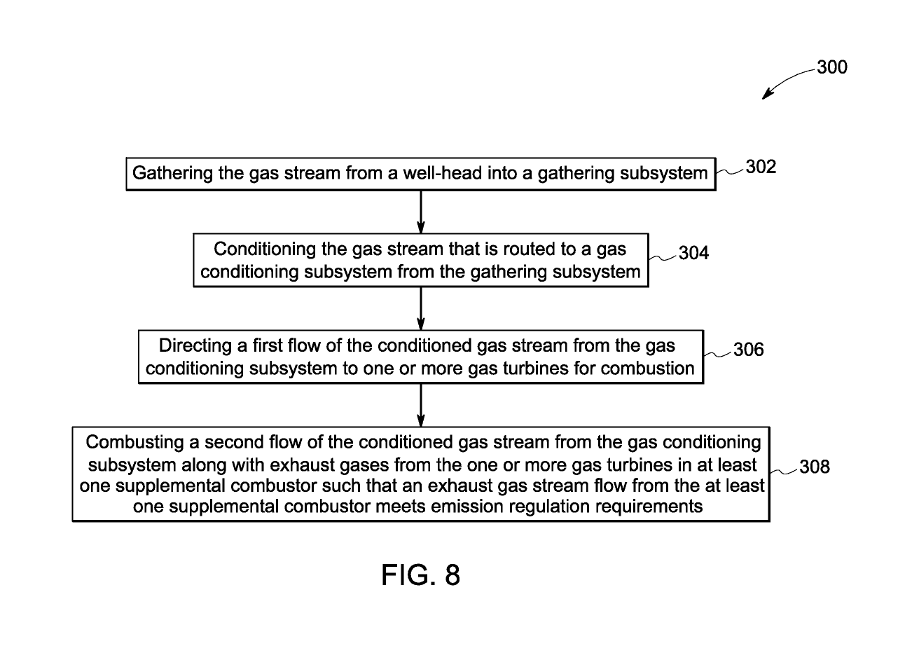

FIG. 8 is a flow chart of a method 300 of processing a gas stream in accordance with an example of the present technology. At step 302, the method includes gathering the gas stream from a well-head into a gathering subsystem. At step 304, the method includes conditioning the gas stream that is routed to a gas conditioning subsystem from the gathering subsystem. The conditioning of the gas stream comprises filtration of solids such as salts, removal of moisture using a plurality of filters and sorbents, separation of higher hydrocarbon gases from lower hydrocarbon gases present in the gas stream, removal of sulphur or sulphur based compounds and heating the gas stream to maintain vapor phase of the gas stream. At step 306, the method also includes directing a first flow of the conditioned gas stream from the gas conditioning subsystem to one or more gas turbines for combustion. The one or more gas turbines are configured to drive a power generation system. Further, at step 308, the method includes combusting a second flow of the conditioned gas stream from the gas conditioning subsystem along with exhaust gases from the one or more gas turbines in at least one supplemental combustor such that an exhaust gas stream flow from the at least one supplemental combustor meets emission regulation requirements. The at least one supplemental combustor includes multistage combustor sections that enables complete combustion and reduction of soot while processing the gas streams for meeting emission regulation requirements.

Furthermore, the method includes capturing carbon dioxide gas from a portion of the exhaust gas stream flow that is routed via a carbon dioxide capture subsystem located downstream of the at least one supplemental combustor. The method also includes processing the lower hydrocarbon gases that are separated from higher hydrocarbon gases to form compressed natural gas products and liquefied natural gas products respectively.

In accordance with another example of the technology, a system for processing a gas stream includes a gathering subsystem configured to collect the gas stream from a well-head. The system also includes a gas conditioning subsystem configured to receive the gas stream from the gathering subsystem and provide physical conditioning of the gas stream. The system includes a liquefied natural gas processing unit configured to process a methane gas to produce a first LNG product and a compressed natural gas processing unit configured to produce a second CNG product. The system also includes one or more gas turbines configured to receive and combust a first flow of the conditioned gas stream from the gas conditioning subsystem and coupled with a power generation system. In one example, the one or more gas turbines are coupled with a boost compressor for handling low pressure gas stream. In another example, the one or more gas turbines are coupled with a pressure regulator for controlling the pressure of gas streams. The one or more gas turbines include fuel flexible combustor sections such as diffusion combustor sections that can handles gas streams having liquid and gaseous phases. In yet another example, these one or more gas turbines includes a fuel-flexible dry low NOx (DLN) combustor for meeting emission regulation requirements.

The power generation system includes an electric generator coupled with an electric load bus for providing power to multiple subsystems including a Gas Conditioning Unit, Liquefied Natural Gas (LNG) processing unit, a Compressed Natural Gas (CNG) processing unit, the carbon dioxide capture subsystem, electric submersible pumps, compressors, well pad hotel loads and off-pad co-production units. The electric load bus includes a power factor correction subsystem having a resistor bank configured to absorb excess electric power and improve power factor of the system. The resistor bank includes a set of electrical resistors with air cooling fans to absorb excess electrical energy. Further, the one or more gas turbines with the diffusion combustor section is configured to receive the first flow of the conditioned gas stream from the gas conditioning subsystem along with higher hydrocarbon gases or liquids that are collected from the methane separation unit, Liquefied Natural Gas (LNG) processing units and Compressed Natural Gas (CNG) processing unit. The one or more gas turbines also include a premixed combustor section instead of the diffusion combustor section in one embodiment.

Furthermore, the system includes at least one supplemental combustor configured to receive heated exhaust gases from the one or more gas turbines and a second flow of the conditioned gas stream from the gas conditioning subsystem. The supplemental combustor is configured to combust the second flow of the conditioned gas stream and the heated exhaust gases such that an exhaust gas stream flow from the at least one supplemental combustor meets emission regulation requirements. Furthermore, the system includes a carbon dioxide capture subsystem located downstream of the at least one supplemental combustor and configured to capture carbon dioxide (CO₂) gas from a portion of the exhaust gas stream flow and convert the captured CO₂ to a concentrated CO₂ or liquid CO₂.

Advantageously, the present technology is directed towards processing the gas streams efficiently such that the combusted gas streams meets the emission regulation requirements. The present technology enables significant reduction of carbon dioxide in the exhaust gases. Further, the present technology leads to production of useful by-products such as CNG, LNG, natural gas liquids and carbon dioxide products. Furthermore, the present technology offers useful production of electrical power that may be used locally to power the various subsystems or support well pad hotel loads or provide power for co-production to off pad users. In addition, the staged configuration of the supplemental combustor and the modular nature of the present technology allow the system to operative effectively over a wide range of well head gas stream flow rates.

Furthermore, the skilled artisan will recognize the interchangeability of various features from different examples. Similarly, the various methods and features described, as well as other known equivalents for each such methods and feature, can be mixed and matched by one of ordinary skill in this art to construct additional systems and techniques in accordance with principles of this disclosure. Of course, it is to be understood that not necessarily all such objects or advantages described above may be achieved in accordance with any particular example. Thus, for example, those skilled in the art will recognize that the systems and techniques described herein may be embodied or carried out in a manner that achieves or improves one advantage or group of advantages as taught herein without necessarily achieving other objects or advantages as may be taught or suggested herein.

While only certain features of the technology have been illustrated and described herein, many modifications and changes will occur to those skilled in the art. It is, therefore, to be understood that the appended claims are intended to cover all such modifications and changes as fall within the true spirit of the claimed inventions.

1. A system for processing a gas stream, the system comprising:
a gathering subsystem configured to collect the gas stream from a well-head;
a gas conditioning subsystem configured to receive the gas stream from the gathering subsystem and provide physical conditioning of the gas stream;
one or more gas turbines configured to receive and combust a first flow of the conditioned gas stream from the gas conditioning subsystem and coupled with an electrical generator; and
at least one supplemental combustor configured to receive heated exhaust gases from the one or more gas turbines and a second flow of the conditioned gas stream from the gas conditioning subsystem, wherein the at least one supplemental combustor is configured to combust the second flow of the conditioned gas stream and the heated exhaust gases such that an exhaust gas stream flow from the at least one supplemental combustor meets emission regulation requirements.

2. The system of claim 1, wherein the physical conditioning of the gas stream by the gas conditioning subsystem comprises filtration of solids such as salts, removal of moisture using a plurality of filters and sorbents, separation of higher hydrocarbon gases from lower hydrocarbon gases present in the gas stream, removal of sulphur or sulphur based compounds and heating the gas stream to maintain vapor phase of the gas stream.

3. The system of claim 2, wherein the gas conditioning subsystem comprises a hydrogen sulphide removal unit for removing the sulphur or sulphur based compounds present in the gas stream.

4. The system of claim 1, further comprising a methane separation unit configured to receive a third flow of the conditioned gas stream from the gas conditioning subsystem and separate lower hydrocarbon gas such as methane gas.

5. The system of claim 4, further comprising a Liquefied Natural Gas (LNG) processing unit configured to process the methane gas to produce a first LNG product.

6. The system of claim 1, further comprising a Compressed Natural Gas (CNG) processing unit configured to receive a fourth flow of the conditioned gas stream from the gas conditioning subsystem and process the conditioned gas stream to produce a second CNG product.

7. The system of claim 1, further comprising a carbon dioxide capture subsystem located downstream of the at least one supplemental combustor and configured to capture carbon dioxide (CO₂) gas from a portion of the exhaust gas stream flow and convert the captured CO₂ to a concentrated CO₂ or liquid CO₂.

8. The system of claim 1, further comprising an electric load bus coupled with the electrical generator for providing power to a plurality of subsystems comprising the Gas Conditioning unit, Liquefied Natural Gas (LNG) processing unit, Compressed Natural Gas (CNG) processing unit, carbon dioxide capture subsystem, electric submersible pumps, compressors, wellpad hotel loads and off-pad co-production units.

9. The system of claim 8, wherein the electric load bus comprises a power factor correction subsystem having a resistor bank configured to absorb excess electric power and improve power factor of the system.

10. The system of claim 1, wherein the at least one supplemental combustor comprises two or more staged combustor sections configured to receive gas streams directly from the well head in addition to the second flow of the conditioned gas stream from the gas conditioning subsystem and the heated exhaust gases from the one or more gas turbines.

11. The system of claim 10, wherein the at least one supplemental combustor comprises a first stage combustor section and a second stage combustor section configured to receive the second flow of the conditioned gas stream from the gas conditioning subsystem and the heated exhaust gases from the one or more gas turbines.

12. The system of claim 11, wherein both the first stage combustor section and the second stage combustor section are configured to receive a portion of gas stream directly from the well head for combustion.

13. The system of claim 1, wherein the one or more gas turbines are fuel flexible gas turbines comprises a diffusion combustor section or a premixed combustor section.

14. The system of claim 13, wherein the one or more gas turbines with the diffusion combustor section is configured to receive the first flow of the conditioned gas stream from the gas conditioning subsystem along with higher hydrocarbon gases or liquids that are collected from the methane separation unit, Liquefied Natural Gas (LNG) processing units and Compressed Natural Gas (CNG) processing unit.

15. The system of claim 1, wherein the one or more gas turbines comprises a fuel-flexible dry low Nitrogen oxide (NOx) combustor for meeting emission regulation requirements.

16. The system of claim 1, wherein the one or more gas turbines are coupled with a boost compressor for handling low pressure gas stream and further coupled with a pressure regulator for controlling the pressure of gas streams.

17. A method of processing a gas stream, the method comprising:
gathering the gas stream from a well-head into a gathering subsystem;
conditioning the gas stream that is routed to a gas conditioning subsystem from the gathering subsystem;
directing a first flow of the conditioned gas stream from the gas conditioning subsystem to one or more gas turbines for combustion, wherein the one or more gas turbines are configured to drive a power generation system; and
combusting a second flow of the conditioned gas stream from the gas conditioning subsystem along with exhaust gases from the one or more gas turbines in at least one supplemental combustor such that an exhaust gas stream flow from the at least one supplemental combustor meets emission regulation requirements.

18. The method of claim 17, wherein the conditioning of the gas stream comprises filtration of solids such as salts, removal of moisture using a plurality of filters and sorbents, separation of higher hydrocarbon gases from lower hydrocarbon gases present in the gas stream, removal of sulphur or sulphur based compounds and heating the gas stream to maintain vapor phase of the gas stream.

19. The method of claim 17, further comprising capturing carbon dioxide gas from a portion of the exhaust gas stream flow that is routed via a carbon dioxide capture subsystem located downstream of the at least one supplemental combustor.

20. The method of claim 17, further comprising separating lower hydrocarbon gases from the conditioned gas stream and processing the lower hydrocarbon gases to form compressed natural gas product and liquefied natural gas product.

21. The method of claim 17, further comprising combusting the second flow of the conditioned gas stream from the gas conditioning subsystem along with exhaust gases from the one or more gas turbines in a first stage combustor section and in a second stage combustor section of the at least one supplemental combustor.

22. The method of claim 21, further comprising providing a first flow of air and a second flow of air in the first stage combustor section and in a second stage combustor section respectively, wherein, the first flow of air is pre-heated by exhaust gases from the gas turbine prior to providing in the first stage combustor section and the second flow of air is pre-heated by the first stage combustor section prior to providing air in the second stage combustor section.

23. A system for processing a gas stream, the system comprising:
a gathering subsystem configured to collect the gas stream from a well-head;
a gas conditioning subsystem configured to receive the gas stream from the gathering subsystem and provide physical conditioning of the gas stream;
a liquefied natural gas processing unit configured to process a methane gas to produce a first liquefied natural gas product;
a compressed natural gas processing unit configured to produce a second compressed natural gas product;
one or more gas turbines configured to receive and combust a first flow of the conditioned gas stream from the gas conditioning subsystem and coupled with a power generation system; and
a carbon dioxide capture subsystem configured to capture carbon dioxide (CO₂) gas from a portion of the exhaust gas stream flow and convert the captured CO₂ to a concentrated CO₂ or liquid CO₂.

24. The system of claim 23, further comprising at least one supplemental combustor configured to receive heated exhaust gases from the one or more gas turbines and a second flow of the conditioned gas stream from the gas conditioning subsystem, wherein the at least one supplemental combustor is configured to combust the second flow of the conditioned gas stream and the heated exhaust gases such that an exhaust gas stream flow from the at least one supplemental combustor meets emission regulation requirements.

25. The system of claim 24, wherein the at least one supplemental combustor comprises a plurality of combustor sections for combustion in a plurality of stages

26. The system of claim 23, wherein the power generation system comprises an electric generator coupled with an electric load bus for providing power to a plurality of subsystems comprising the Liquefied Natural Gas processing unit, the Compressed Natural Gas processing unit, the carbon dioxide capture subsystem, electric submersible pumps, compressors, well pad hotel loads and off-pad co-production units.

27. The system of claim 23, wherein the liquefied natural gas processing unit is configured to process the methane gas to produce a third natural gas liquid product.
